(19) United States
(12) Patent Application Publication
(10) Pub. No.: US 2007/0233619 A1
(43) Pub. Date: Oct. 4, 2007

(54) COMPUTER READABLE RECORDING MEDIUM HAVING DESIGN CREATION SUPPORTING PROGRAM STORED THEREON, DESIGN CREATION SUPPORTING APPARATUS AND COMPUTER DATA SIGNAL FOR SUPPORTING DESIGN CREATION

(75) Inventors: Yoshitsugu Hirose, Kanagawa (JP); Kazushi Ozawa, Tokyo (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/695,250

(22) Filed: Apr. 2, 2007

(30) Foreign Application Priority Data
Apr. 4, 2006 (JP) 2006103673

(51) Int. Cl. G06F 17/00

(52) U.S. Cl. 706/11

(57) ABSTRACT

The process extracts an amount of feature from the design of the actual document, extracts impression information and its weighting factor that are associated with the extracted amount of feature, and presents information representing an evaluation value calculated based on impression information extracted from the plural design evaluation databases and the weighting factor for each item of impression information extracted for the plural design evaluation databases.

### CROSS-REFERENCE TO RELATED APPLICATIONS

This application is based on, and claims priority under 35 USC 119 from, Japanese Patent Application No. 2006-103673 filed on Apr. 4, 2006.

### BACKGROUND

1. Technical Field

The present invention relates to a computer readable recording medium having stored thereon a design creation supporting program that supports design creation based on an intended impression of the design, an impression of an actually created design, and an impression a user receives from a design, a design creation supporting apparatus and a computer data signal for supporting design creation.

2. Related Art

Designs of company cooperate marks, goods, reference materials for presentation, website pages, and so on significantly affect the impression given to customers and users, and so on. Thus, in design creation, it is important to appropriately and precisely represent an impression which persons attempting to provide corporate strategies and marketing strategies or provide information wish to make on receivers (users).

When one requests design creation of a product to a design creator, for example, as shown in the flowchart in FIG. 34, a client, who is a requesting person, determines a desired impression required for the product or presentation materials of the product (S100), and the design creator produces a design matching the desired impression (S102). The impression of the produced design is then evaluated (S104), and based on a difference between the required impression and the impression of the actual design, the requesting person provides instructions for changing the design, if it is necessary, and otherwise, the design is finally determined (S106).

With regard to such design creation as described above, a large number of software applications have been developed for supporting image rendering and coloring of products or documents such as presentation materials and web pages. In most of these applications, however, actual coloring is left to application users, leading to a problem that users not skilled in design creation would have difficulty in appropriately and precisely representing a desired impression.

In order to deal with the above difficulty, studies and research have been made concerning a method for performing a process and evaluating an impression of a document based on human sensibilities.

### SUMMARY

According to an aspect of the present invention, there is provided computer readable recording medium storing a design creation supporting program causing a computer having a memory that stores a plurality of design evaluation databases in which an amount of physical features in a design of a document, impression information representing an impression sensed by a human viewing the document, and a weighting factor of the impression information are associated with one other, to execute a process for supporting design creation below.

That is to say, the design creation supporting program causes the computer to extracting the amount of a feature from the design of the actual document, extracting impression information and its weighting factor that are associated with the amount of feature extracted in the amount of feature extracting process by referencing the plural design evaluation databases, and an outputting process for presenting information representing an evaluation value calculated based on image information extracted from the plural design evaluation databases in the process for extracting the impression information and its weighting factor and the weighting factor for each of the items of image information extracted for the plural design evaluation databases.

### BRIEF DESCRIPTION OF THE DRAWINGS

Exemplary embodiments of the present invention will be described in detail based on the following figures, wherein:

FIG. 1 is a block diagram of the entire configuration of a design creation supporting apparatus in an exemplary embodiment of the present invention;

FIG. 2 is a block diagram of a configuration of a management server in an exemplary embodiment of the present invention;

FIG. 3 is a main flowchart of a design creation supporting method in an exemplary embodiment of the present invention;

FIG. 4 is a diagram showing a main menu screen in an exemplary embodiment of the present invention;

FIG. 5 is a diagram showing a flowchart of a desired impression decision process in an exemplary embodiment of the present invention;

FIG. 6 is a diagram showing a desired impression input screen in an exemplary embodiment of the present invention;

FIG. 7 is a diagram showing an impression representing database in an exemplary embodiment of the present invention;

FIG. 8 is a diagram showing an impression map in an exemplary embodiment of the present invention;

FIG. 9 is a diagram showing an impression evaluation database in an exemplary embodiment of the present invention;

FIG. 10 is a diagram showing an impression evaluation database in an exemplary embodiment of the present invention;

FIG. 11 is a flowchart of a design impression evaluation process in an exemplary embodiment of the present invention;

FIG. 12 is a diagram showing a design impression evaluation screen in an exemplary embodiment of the present invention;

FIG. 13 is a diagram showing a design database in an exemplary embodiment of the present invention;

FIG. 14 is a diagram showing an example of a web page in an exemplary embodiment of the present invention;

FIG. 15A and FIG. 15B are a diagram showing a design evaluation databases in an exemplary embodiment of the present invention;

FIG. 16 is a diagram showing a flowchart of a user impression acquisition process in an exemplary embodiment of the present invention;

FIG. 17 is a diagram showing a document data selection screen in an exemplary embodiment of the present invention;

FIG. 18 is a diagram showing a user impression input screen in an exemplary embodiment of the present invention;

FIG. 19 is a diagram showing a user impression information database in an exemplary embodiment of the present invention;

FIG. 20 is a diagram showing a flowchart of an impression presentation/correction process in an exemplary embodiment of the present invention;

FIG. 21 is a diagram showing a display selection screen in an exemplary embodiment of the present invention;

FIG. 22 is a diagram showing an impression map screen in an exemplary embodiment of the present invention;

FIG. 23 is a diagram showing an impression display database in an exemplary embodiment of the present invention;

FIG. 24 is a diagram showing an impression map screen on which items of desired impression information are superimposed;

FIG. 25 is a diagram showing an impression map screen on which items of desired impression information are superimposed;

FIG. 26 is a diagram showing an impression map screen displaying impression information and evaluation values registered in a design database;

FIG. 27 is a diagram showing an impression map screen displaying impression information and evaluation values registered in a design database;

FIG. 28 is a diagram showing difference values of an impression map screen displaying impression information and evaluation values registered in a design database;

FIG. 29 is a diagram showing an impression map screen displaying the lower value of the impression information and the evaluation values registered in the design database;

FIG. 30 is a diagram showing an impression map screen on which items of user impression information are superimposed; and

FIG. 31 is a diagram showing a flowchart of design creation.

### DETAILED DESCRIPTION

### 1. Device Configuration

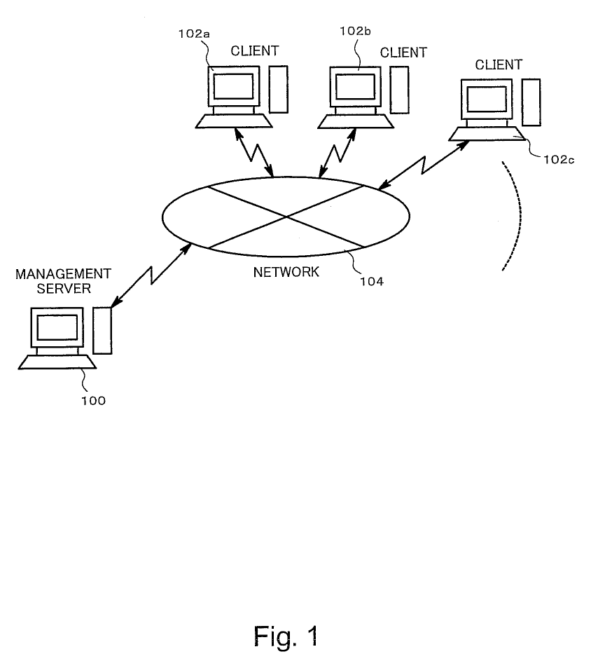

A design creation supporting apparatus in an exemplary embodiment of the present invention includes a management server 100, client computers 102a, 102b, . . . , and a network 104 as shown in FIG. 1. The management server 100 and the client computers 102a, 102b . . . are connected so as to be able to transfer information via the network 104.

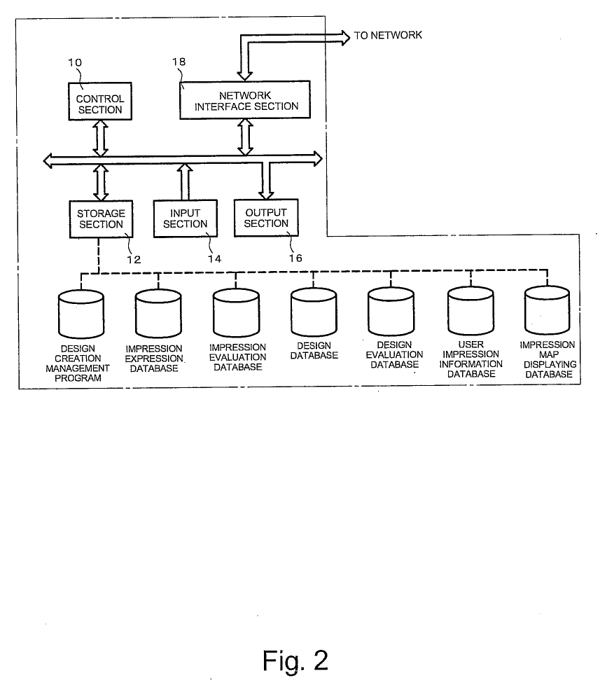

The management server 100 basically includes a control section 10, a storage section 12, an input section 14, an output section 16 and a network interface section 18 as shown in FIG. 2.

The control section 10 reads out the design creation supporting program saved in the storage section 12 and executes it. It captures data required for processing from the input section 14 and the network 104, and stores it into the storage section 12. If it is required for processing, it reads out data kept in the storage section 12 and causes the data to be processed. It further stores the processed result in the storage section 12 and outputs to the output section 16 or the network 104 as required.

The storage section 12 stores or keeps the design creation supporting program and various types of data such as keyword and the like captured from the input section 14 or the network. It also stores and keeps databases such as an impression expression database, an impression evaluation database, a design evaluation database, a design database, a user impression information database, an impression map display database and the like, that are required for processing. The contents and usage of each database will be described later. As the storage section 12, a semiconductor memory is mainly used, but, a storage device such as a hard disk, an optical disk, a magnet-optic disk, a magnetic tape or the like may be used.

The input section 14 is used when data required by a user for processing is input. As the input section 14, for example, a character device such as a keyboard or a pointing device such as a mouse or a light pen can be used. When existing presentation materials or the like created on the recording medium such as a sheet of paper are read in as electronic data, a document reading device such as a scanner or the like, and an audio input device for enabling conversion into a digital signal when audio is input, are provided.

The output section 16 displays an input screen for prompting to input data required for processing, an output screen showing a processing result at the control section 10 and the like. As the output section 16, for example, a document output device such as a display, a printer and the like can be used.

The network interface section 18 is used for connecting the management server 100 so as to be able to communicate information with the network 104.

The client computers 102a, 102b, . . . also have a basic configuration of a computer, as the management server 100 does. The client computers 102a, 102b . . . can also send information required for processing to the management server 100 or receive the processing result in the management server 100 over the network 104. A part of the processing of the design creation supporting method shown below may be executed by the client computer 102.

### 2. Design Creation Supporting Method

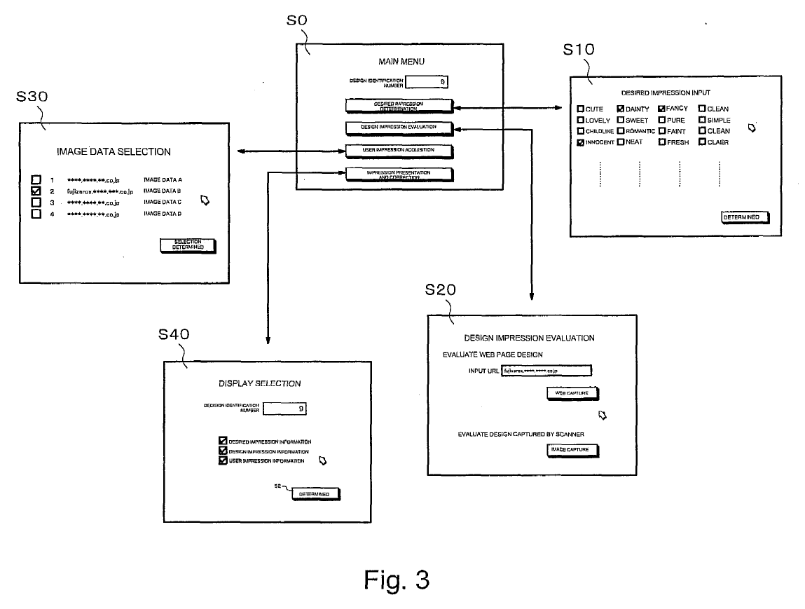

The design creation supporting method in an exemplary embodiment will be detailed with reference to FIG. 3. Each unit in the present invention according to the claims is implemented by causing a computer to process each process of the design creation supporting method below.

In the description, it is assumed that a person who creates a design (hereinafter, referred to as a design creator), a person who requests the design creator to create a design (hereinafter, referred to as a client), and a person who receives a created design (hereinafter, referred to as a user), use the system. The operations that can be performed by the design creator, the client and the user are assumed to be generally performed by an operator. Usually, the design creator, the client and the user are different, but the design creator, the client and the user may sometimes be the same when the design creator appropriately corrects the design created by themselves.

The client computers 102a, 102b . . . respectively communicate with the management server 100 via the network 104, being able to function as a design creator's terminal or a client's terminal respectively. In the description below, the operator is assumed to perform processing by using the management server 100.

The design creation supporting method includes a desired impression decision process in step S10, a design impression evaluation process in step S20, a user impression acquisition process in step S30 and an impression presentation/correction process in step S40, as in FIG. 3.

The respective processes are implemented as the design creation supporting program that can be processed by the computer, and is stored and kept in the storage section 12 of the management server 100, and the management server 100 is caused to execute the program.

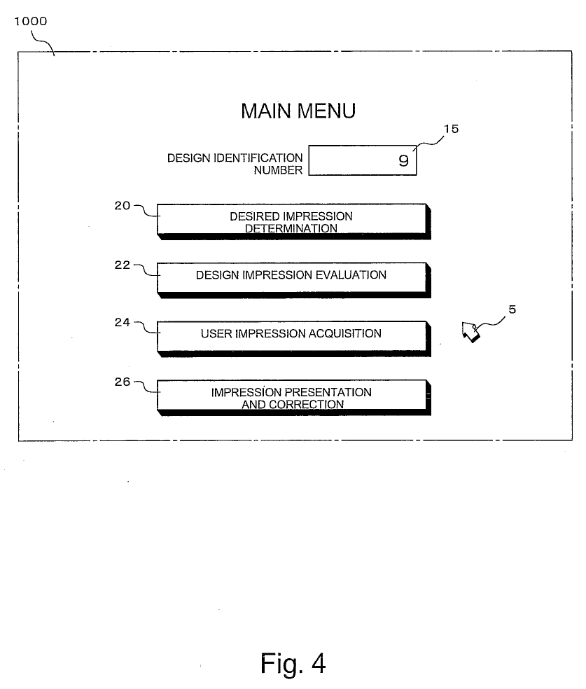

When the processing of the program starts, in step S0, as shown in FIG. 4, the control section 10 causes the output section 16 to display a main menu screen and prompts the operator to select desired processing. Here, on the main menu screen 1000, a mouse pointer 5 is displayed, and in response to clicking on a screen position showing a desired processing, execution of each processing is started.

On the main menu screen 1000, a box 15 for inputting an identification number for a design to be created is provided. A database or the like that is subjected to the processing below is identified by the number inputted in the box 15.

For example, when “9” is inputted in the box 15 as the identification number, a mouse pointer 5 is moved to a place where a desired impression decision button 20 is displayed, and the mouse clicked, so the identification number of the design becomes 9 and the processing proceeds to a desired impression decision process in step S10. Similarly, when the processing is to proceed to the design evaluation process in step S20, the user impression acquisition step in step S30 and the impression presentation/correction step in step S40, the processing can made to advance by moving the mouse pointer 5 to a place where each of a design impression evaluation button 22, a user impression acquisition button 24 and an impression presentation/correction button 26 is displayed, and clicking the mouse.

### 2-1. Desired Impression Deciding Process

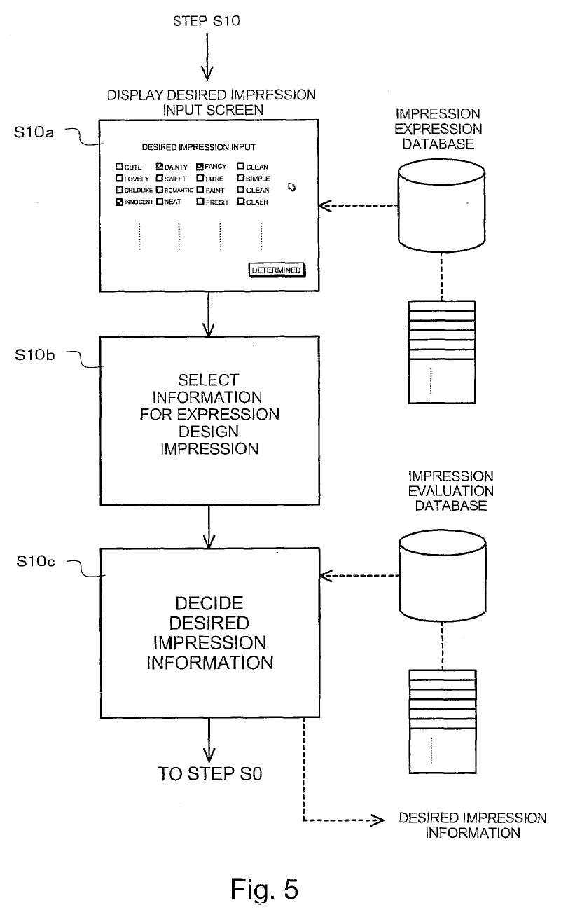

At the desired impression deciding process as the step S10, information on an impression required for design to be created (hereinafter, referred to as desired impression information) is defined. The desired impression deciding process is processed according to the flowchart shown in FIG. 5.

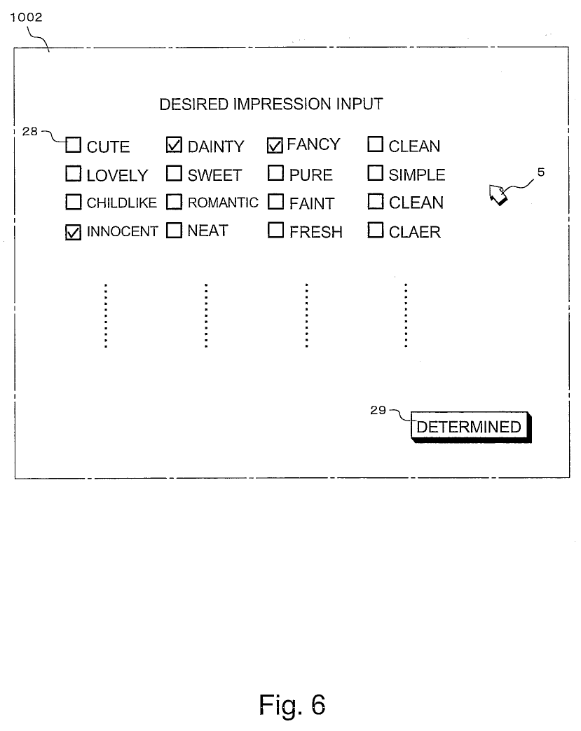

In step S10a, the control section 10 causes the output section 16 to display the desired impression input screen 1002. The desired impression input screen 1002 presents plural items of information representing an impression of the design (options) as shown in FIG. 6 for a client to select information (option) that matches a desired impression of the design creation.

Here, it is preferable to select and use character information including groups of adjectives plainly representing an impression of the design, color information including groups of color palettes of combination of colors and abstract images and the like abstractly representing an impression of the design as required for information representing an impression of the design according to the target of the design creation. Those items of information are previously saved in the storage section 12 as an impression expression database so that it can be used by being read as required.

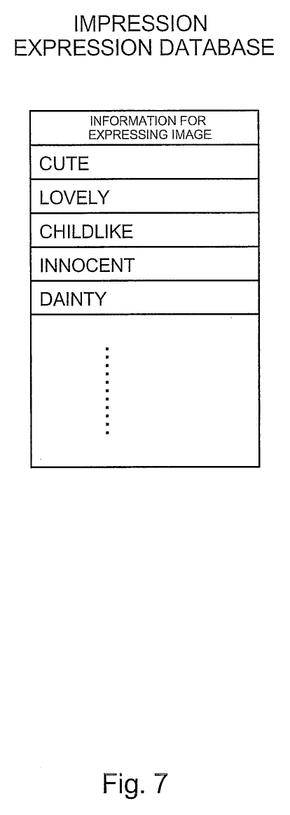

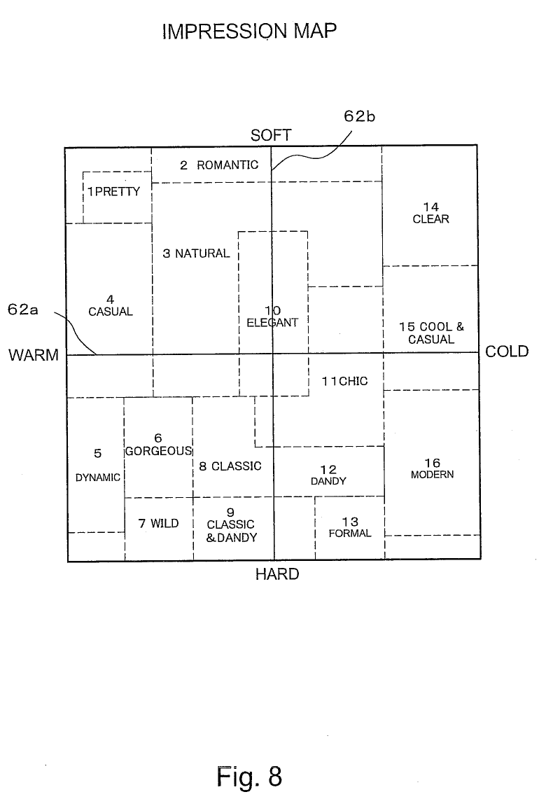

In the exemplary embodiment, first, an impression of the document is acquired from a user by using the impression expression database of FIG. 7. The impression expression database includes representations covering the whole of the impression map as shown in FIG. 8. Here, an impression map is such that the display screen is divided into plural regions and each region is allocated as a region showing an impression of a document. Each map is provided with coordinates, to which information representing an impression is allocated so that an impression changes in a predetermined tendency according the coordinates. For example, in the example in FIG. 8, two orthogonal coordinates of an X coordinate indicating warmth of the design from “warm” to “cold” and a Y coordinate indicating hardness of the design from “soft” to “hard” are provided, and information representing impressions according to change in respective impression are allocated. The method of allocating information to an impression map is not limited to that described above, and setting of the coordinates can be changed according to the item of desired design.

Here, as shown in FIG. 6, the desired impression input image 1002, on which adjectives read out from the impression expression database are listed, is displayed on the output section 16.

In step S10b, the client selects information according to an impression required for the design by using the input section 14. The client creating a document selects one information by moving a mouse pointer 5 superimposed on the desired impression input image 1002 by a mouse as the input section 14, and clicking the mouse while placing the mouse pointer 5 on the check box 28 provided for adjectives appropriate for the impression required for the design. In the selected check box 28, a check mark is displayed. When selection is done, character information of the selected adjective is saved in the storage section 12 by moving the mouse pointer 5 to the place of the decision button 29 is plotted and clicking the mouse on it. In the example of FIG. 6, character information such as “innocent”, “dainty”, and “fancy” is selected and saved in the storage section 12.

The selection method of information representing images is not limited to that described above, and another method can be used as long as the method enables a client to easily perform input.

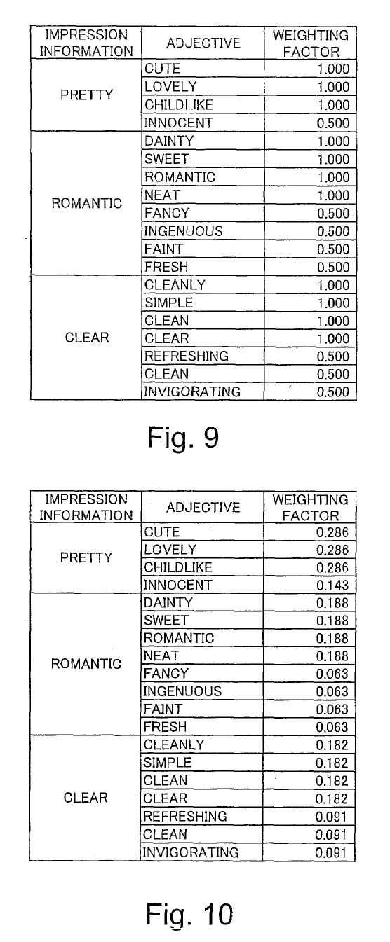

In step S10c, based on the information selected in step S10b (adjective), desired impression information in creating the design of a document is defined. The impression evaluation database is used for deciding the desired impression information. In the impression evaluation database, as shown in FIG. 9, a weighting factor indicating the relative level of importance impression information between each item of information (adjective) included in the impression expression database and each item of information (adjective) associated with each item of impression information is associated with impression information in correspondence with a section representing an impression on the impression map, and kept. Each item of information (adjective) is associated with one weighting factor.

The control section 10 reads out information selected in step S10b from the storing part 12 and references the impression evaluation database as shown in FIG. 9 to extract impression information associated with the read out information and a weighting factor for the impression information. The extracted impression information and weighting factor are saved in the storage section 12 in association with the identification number of the design.

For example, if the selected character information is “innocent”, in the example of the impression evaluation database of FIG. 9, “pretty” is extracted as impression information, and 0.500 is extracted as a weighting factor for “pretty”. If “dainty” is selected, “romantic” is extracted as impression information and 1.000 is extracted as a weighting factor for “romantic”. If “fancy” is selected, “romantic” is extracted as impression information and 0.500 is extracted as a weighting factor for “romantic”.

The control section 10 calculates the sum of weighting factors as an evaluation value for each item of selected impression information. Then, it sets impression information with the biggest value of evaluation values among respective item of impression information as desired impression information.

In the example above, the evaluation value for each item of impression information is 0.500 for “pretty” and 1.500 for “romantic”. Therefore, “romantic”, with the biggest evaluation value, is selected as the desired impression information.

It is preferable to place the impression information with the biggest evaluation value, the impression information with the second biggest evaluation value, and the impression information with the third biggest evaluation value as the desired impression information that is a target of design in the main region, the sub region and the accent region of the document, respectively.

It is assumed that the desired impression information is defined based on information selection only by a client, but it is possible to define the desired impression information based on the information acquired from plural persons by repeating the abovementioned steps. For example, it is quite effective to extract desired impression information on a corporate color of the company from plural company officials, or to extract desired impression information on the design of the commodity product from plural persons in charge of developing a commodity product.

The sum of weighting factors is calculated by causing each client to select an adjective, extracting impression information and making the sum of the weighting factors for respective items of extracted impression information as a product value. Further, product values of impression information for plural clients are added for each item of impression information, to make it an evaluation value, and the impression information with the biggest evaluation value is used as the desired impression information.

It is preferable that a client makes intervals repeating the above-mentioned steps to define the desired impression information in consideration with a change of impression in time for design desired by the client.

One client calculates the sum of the weighting factor for each item of impression information extracted for each time the above processing is performed as a product value, adds the product values of the items of the impression information for each item of impression information to make it an evaluation value, and the impression information with the biggest evaluation value is made the desired impression information.

Although it is assumed that the evaluation value is the sum of weighting factors for respective items of impression information in the exemplary embodiment, the evaluation value is not limited to that. For example, the evaluation value may be calculated based on a weighting factor by a predetermined function, such as making it a product of the weighting factors for respective items of impression information.

In the exemplary embodiment, the weighting factor associated with each item of information is set based on the level of importance of each item of information for respective impression information, and thus the desired impression information clearly indicates the tendency of the impression that is a target of the design creation.

### <Modification>

In the above-mentioned exemplary embodiment, the processing is performed by using a weighting factor that is set based on the level of importance of each item of information for respective items of impression information. In this modification, the processing is performed by setting the weighting factor so that each item of impression is to be evaluated evenly.

In step S10c, the desired impression information in creating the design of a document is defined based on information selected in step S10b (adjective). Here, the processing is performed by using the impression evaluation database shown in FIG. 10. In the impression evaluation database, a weighting factor for each item of information (adjective) is set so that the sum of the weighting factors of the information (adjective) associated with each item of impression information is the equal. Each item of information (adjective) is associated with a weighting factor.

The control section 10 reads out information selected in step S10b from the storing part 12 and references the impression evaluation database as shown in FIG. 10 to extract impression information associated with the read out information and a weighting factor for the impression information. The extracted impression information and weighting factor are saved in the storage section 12 in association with the identification number of the design.

For example, if the selected character information is “innocent”, in the example of the impression evaluation database of FIG. 10, “pretty” is extracted as impression information, and 0.143 is extracted as a weighting factor for “pretty”. If dainty is selected, “romantic” is extracted as impression information and 0.188 is extracted as a weighting factor for “romantic”. If “fancy” is selected, “romantic” is extracted as impression information and 0.063 is extracted as a weighting factor for “romantic”.

The control section 10 calculates the sum of weighting factors as an evaluation value for each item of selected impression information. Then, it sets impression information with the biggest value of evaluation values among respective items of impression information as desired impression information.

In the example above, the evaluation value for each item of impression information is 0.143 for “pretty” and 0.251 for “romantic”. Therefore, “romantic” with the biggest evaluation value is selected as the desired impression information.

It is assumed that the desired impression information is defined based on the information selection only by a client, but it is also possible to define the desired impression information based on the information acquired from plural persons by repeating the abovementioned steps. For example, it is quite effective to extract desired impression information on a corporate color of the company from plural company officials, or to extract desired impression information on the design of the commodity product from plural persons in charge of developing a commodity product.

It is calculated by causing each client to select an adjective, extracting impression information and making the sum of the weighting factors for respective items of extracted impression information a product value. Further, product values of impression information for plural clients are added for each item of impression information to make it an evaluation value, and the impression information with the biggest evaluation value is made the desired impression information.

It is preferable that a client makes a time in repeating the above-mentioned steps to define the desired impression information in consideration with a change of impression in time for design desired by the client.

One client calculates the sum of the weighting factors for each item of the impression information extracted for each time the above processing is performed as a product value, adds the product values of the items of impression information for each item of impression information to make it an evaluation value, and the impression information with the biggest evaluation value is made the desired impression information.

Although it is assumed that the evaluation value is the sum of weighting factors for respective items of impression information in the modification, the evaluation value is not limited to that. For example, the evaluation value may be calculated based on a weighting factor by a predetermined function such as making it a product of the weighting factors for respective items of impression information.

In the exemplary embodiment, as the weighting factor associated with each item of information is set so that each item of impression information is evenly evaluated, it is appropriate for the case where impressions that are subjected to the design creation are compared between items of impression information, or compared with the evaluation result of another impression.

Both of the impression information databases shown in FIG. 9 and FIG. 10 may be stored in the storage section 12, and one of them selected as required and referenced. For example, in step S10c, it is preferable to cause a user to select which impression information database to reference and perform the processing by referencing the database selected by the user. That makes it possible to select from extracting the desired impression information that clearly shows a tendency of an impression that is subjected to the design creation, and extracting the desired impression information so that it is clearly compared with other impression information.

### 2-2. Design Impression Evaluation Process

When the design impression evaluation button 22 is clicked in step S0, the processing proceeds to the design impression evaluation process in step S20.

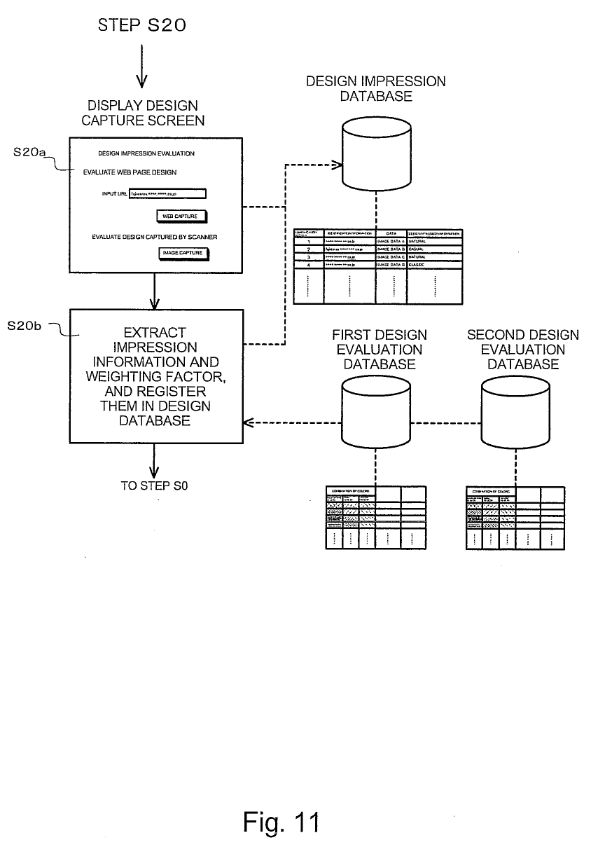

In the design evaluation process in step S20, information on an impression of the design of the document (hereinafter, referred to as a design impression information) is extracted. The design impression evaluation process is processed along with the flowchart of FIG. 11.

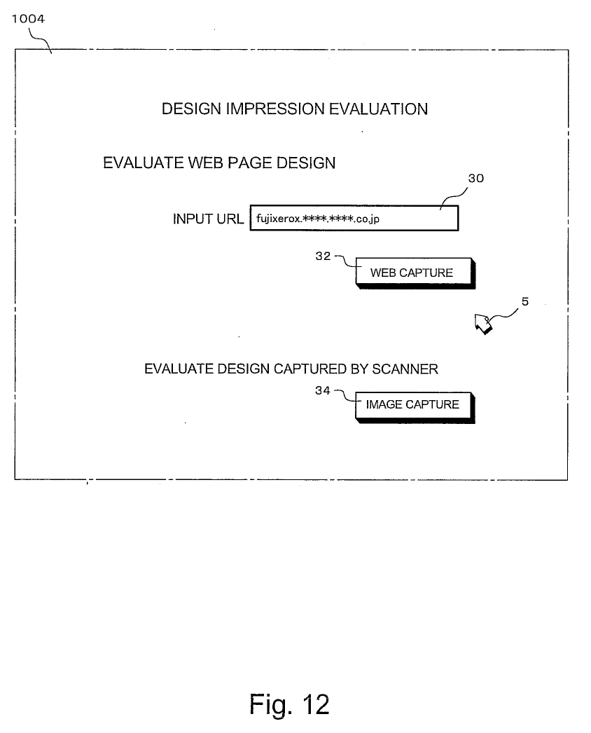

First in step S20a, the actual document data is captured and stored and kept in the storage section 12. The control section 10 displays the design capture screen 1004 on the output section 16 as shown in FIG. 12, and prompts the design creator to input a document relating to the design that is subjected to the evaluation.

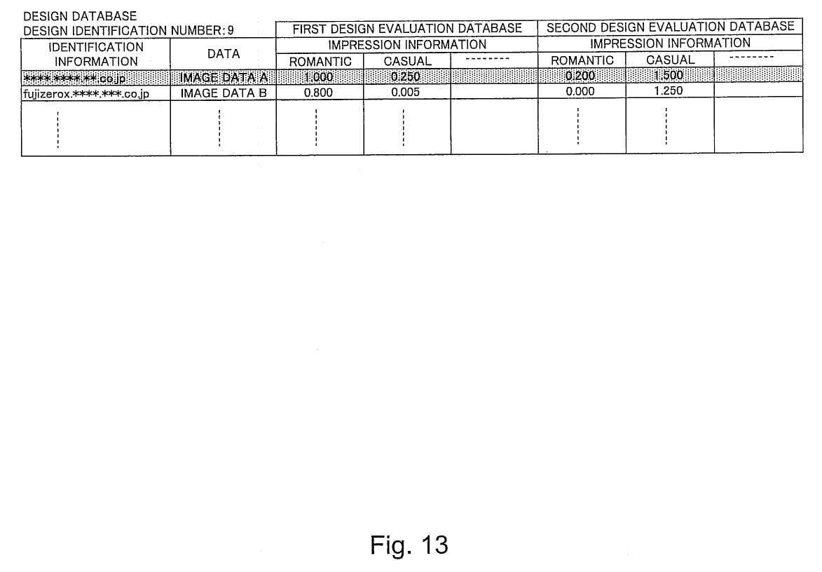

For example, the design creator designs the web page and uploads it on the network 104 in advance. Next, the design creator specifies where to acquire a web page that is subjected to the design impression evaluation by inputting the URL of the web page in the URL input box 30 on the design capture screen 1004, moving the mouse pointer 5 displayed on the design capture screen 1004 to the web design capture button 32, and clicking the mouse on it. When the control section 10 receives the specification, it captures document data of the web page from the specified URL via the network 104. As shown in FIG. 13, the captured document data is associated with the identified information (for example, URL) of the document data and accumulated in the storage section 12 in order as the design database.

If the design database has not been generated for the identification number of the design, a new design database is generated in association with the identification number of the design. On the other hand, if a design database for the identification number of the design is not present, the identification information of the document data and the document data are additionally accumulated for the existing design database.

By specifying not only the created web page but also the URL of the web page of the competing company, for example, it is possible to acquire the document data of the web page and evaluate it.

If the object of the design creation is the presentation material, new product or the brand logo of the company and the like, it is preferable to acquire the document data by using a reading device such as a scanner. In such a case it is preferable to activate the existing document reading tool by clicking the document capture button 34 on the design capture screen 1004.

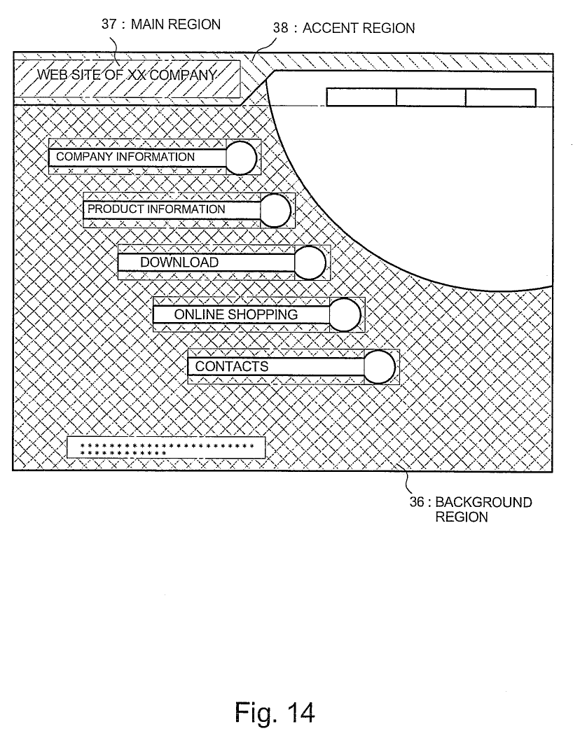

In the description below, it is assumed that a document of the web page of FIG. 14 is captured as an example.

In step S20b, an impression of the captured document data given to a person is evaluated.

First, the control section 10 reads out image data of the document to be evaluated from the storage section 12 and divides into regions as shown in FIG. 14. For dividing into regions, the existing image region dividing tool can be used. Next, the amounts of the physical features such as an area, a place, a size, a color average, a color difference with respect to other regions and the like are extracted in each divided region. The amount of the physical feature is preferably extracted without dividing the document. The amount of the physical feature is preferably a visual amount of the features.

Each region is preferably converted from the RGB color space into L*a*b* color space and then the visual amount of a feature is extracted. Usually, the document data used in a computer is represented in the RGB color space, which is an uneven color space, so analyzing with the sensibility of a person cannot be performed. By converting the region from the RGB color space, which is an uneven color space, into the L*a*b* color space, which is an even color space, the region can be analyzed and evaluated as an image closer to that perceived by a person. The L*a*b* color space is also preferable from the viewpoint that it can represent the dynamic range of the document. It is a matter of course that if the document data is already represented in the L*a*b* color space, no conversion is needed.

The amount of a physical feature is the feature such as an area of a region concerned, a width w and a height h of the region concerned, places x and y at the upper left, a color average of the entire region concerned, an average value of the L* component, an average value of the a* component, an average value of the b* component, a color difference ΔL*a*b* between the color average of the entire document and the color average of the entire region concerned, a color difference ΔₙL*a*b* of the color average with respect to the region adjacent to the region concerned, a color difference A_{b}L*a*b* of the color average between the background and the region concerned, color distribution in a region concerned and the number of the regions having the same color. The average color is extracted from a background region of the document data, a main region with the biggest region except for a background region and an accent region that is an accent to the main region to be the amount of feature.

On the other hand, the combination of the amount of the physical features is stored and kept in the storage section 12 in association with impression information, which is a section representing an impression of the design, and a weighting factor indicating the strength of a relationship between the amount of physical features and impression information as the design evaluation database. In the exemplary embodiment, two design evaluation databases are prepared. The first design evaluation database is a database that is generated by the quantification third class statistical analysis method based on an impression a group of examinees which forms an average population got immediately after viewing plural documents with different amounts of physical features. The first design evaluation database is referenced as a database for evaluation of an intuitive impression a person got at first sight of a design of a document. The second design database is a database generated by the quantification third class statistical analysis method based on an impression a group of examinees which forms an average population got after viewing plural documents with different amounts of physical features for a predetermined period of time (at least a longer period than that the first design evaluation database is generated). The second design evaluation database is referenced as a database for evaluating a rational impression got after a person carefully examined a design of the document.

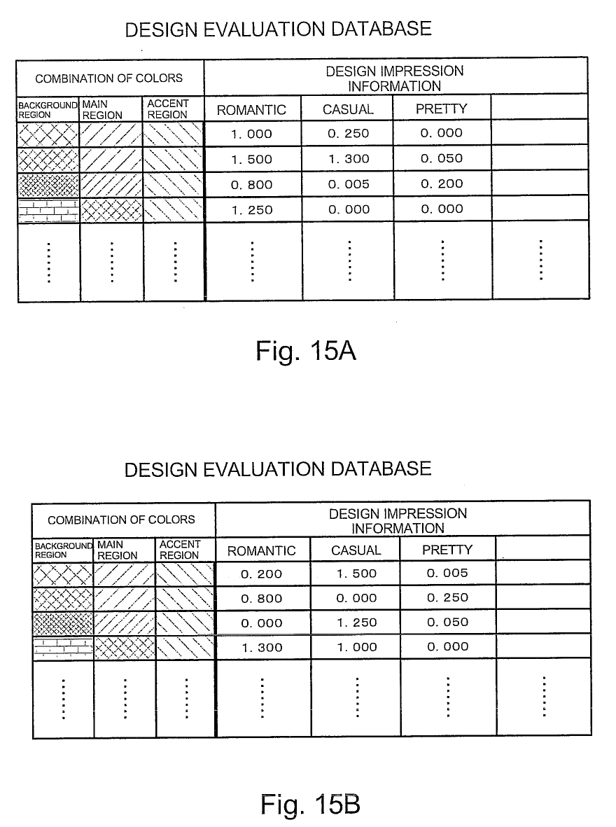

For example, as shown in FIG. 15A and FIG. 15B, sets of colors for each of a background region, a main region with the biggest region except for a background region and an accent region that is an accent to the main region are generated (in the figures, colors are indicated by hatching) and saved in association with design impression information representing the impressions a person got from the sets and the weighting factors for them.

Then, an average color is extracted from the background region, the main region and the accent region of the actual document data, and the impression information and the weighting factor are extracted from the first and the second design evaluation database respectively. For each design evaluation database, an evaluation value is calculated based on the weighting factor for each item of impression information. The extracted impression information and evaluation value are stored and kept in the storing part 12 as a design database of the document data in association with identification number of the document data and the document data to be evaluated as shown in FIG. 13.

In such a manner, based on the amount of physical feature extracted from the document to be evaluated, both the impression intuitively got by a user who saw the document to be evaluated and the impression rationally got by a user are acquired.

For example, when an average color is extracted from the background region, the main region and the accent region of the main data of FIG. 14, impression information “romantic”, a weighting factor 1.000, impression information “casual”, a weighting factor 0.250 . . . are extracted based on the first design evaluation database of FIG. 15A. Impression information “romantic”, a weighting factor 0.200, impression information “casual”, a weighting factor 1.500, impression information “pretty” and a weighting factor 0.005 . . . are extracted based on the second design evaluation database of FIG. 15B. The data are registered in the design database as impression information and an evaluation value for each item of impression information (in FIG. 13, it is indicated by hatching).

If a document is divided, an amount of features are extracted from respective regions and evaluated, an evaluation value may be calculated by adding an extracted weighting factor of impression information extracted for each divided region of a document to each item of the impression information for each design evaluation database, and an evaluation value for each item of impression information may be registered in the database. For example, if a document is divided into the image region 1 and 2, and impression information “romantic” and a weighting factor 1.000 are extracted based on the first design evaluation database and impression “casual” and a weighting factor 0.500 are extracted based on the second design evaluation database for the image region 1 and impression information “romantic” and a weighting factor 0.200 are extracted based on the first design evaluation database and impression information “casual” and a weighting factor 0.400 are extracted based on the second design evaluation database for the image region 2, an evaluation value of the impression information “romantic” is 1.200 for the first design evaluation database and an evaluation value of the impression information “casual” is 0.900 for the second design evaluation database. The design database is registered.

Although it is assumed that an evaluation value is the sum of the weighting factors of respective items of impression information in the exemplary embodiment, the evaluation value is not limited to being acquired in this manner. For example, the evaluation value may be calculated based on a weighting factor by a predetermined function such as making it a product of weighting factors for respective items of impression information.

For the amount of features that can be used for extracting information on an impression, an area of the region, a width w and a height h of a region, upper left places x and y, a color average for the entire region, an average value of L* component, an average value of a* component, an average value of b* component, a color difference ΔL*a*b* of a color average for the entire region and a color average for a region concerned, a color difference ΔₙL*a*b* of a color average between the region concerned and a region adjacent to the region concerned, a color difference Δ_{b}L*a*b* of a color average between a background and the region concerned, color distribution in the region concerned and the number of the regions having the same color may be used.

A multidimensional database in which conditions of combination of the amounts of features and expression information on an impression of a document are associated with each other may be used. As such, by combining the amount of features as much as possible, an impression given by the document to a person may be further detailed. Particularly, with conditions including difference among the amounts of features between the different document regions such as a color difference between document regions, expression information representing an impression got from a part or the like with a strong contract in the document to be evaluated can be extracted.

When a design impression is selected, the design impression evaluation process finishes and the control section 10 returns control to the step S0.

### 2-3. User Impression Acquisition Process

When the user impression acquisition process button 24 is clicked in step S0, the processing proceeds to the user impression acquisition process in step S30.

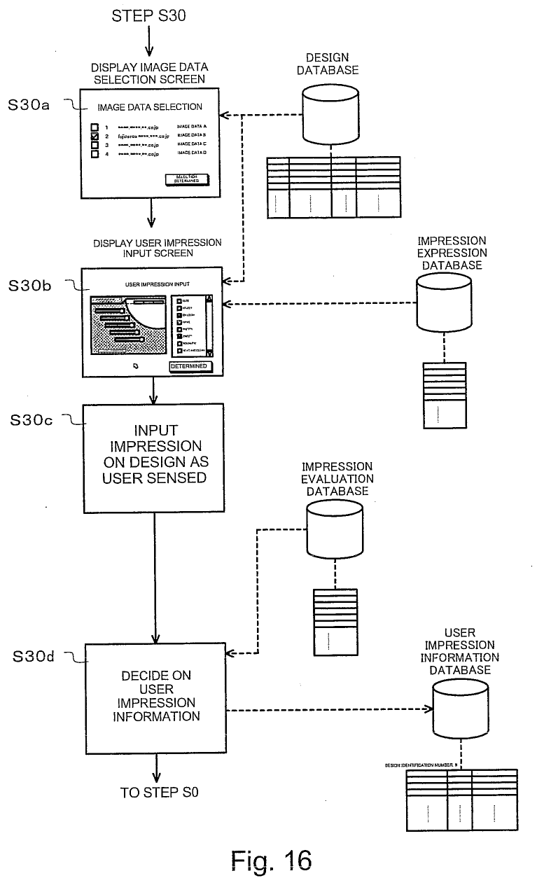

At the user impression acquisition process in step S30, an impression got by the user for the document data captured in step S20 (hereinafter referred to as the user impression information) is acquired. The user impression acquisition process is processed according to the flowchart shown in FIG. 16.

First in step S30a, the control section 10 causes the output section 16 to display a document data selection screen 1006A, and prompts a user to select the document data to be subjected to impression acquisition in the document data captured in step S20.

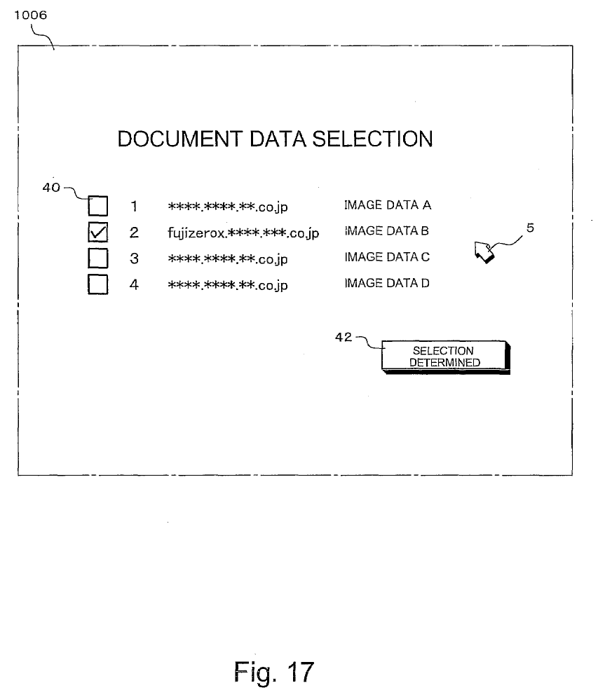

It is preferable that the document data selection screen 1006 displays information on the document data kept in the database of the storing part 12 on the screen as a list as shown in FIG. 17 for the user to select which document data the user impression information is acquired for. The aspect of the document data selection screen 1006 is not limited to this, and any screen can be used as long as it enables a user to select the document data kept in the design database.

A user for inputting an impression for the document data selects information by moving the mouse pointer 5 to the check box 40 provided for each information on the document data (image data) of the document data selection screen 1006 and clicking the mouse by using the input section 14 such as a mouse or the like. Next, the user confirms the selection of the document data by moving the mouse pointer 5 to the selection determined button 42 and clicking the mouse on it.

In step S30b, the control section 10 causes the output section 16 to display the user impression input screen 1008 and prompts the user to input an impression the user got by the document data.

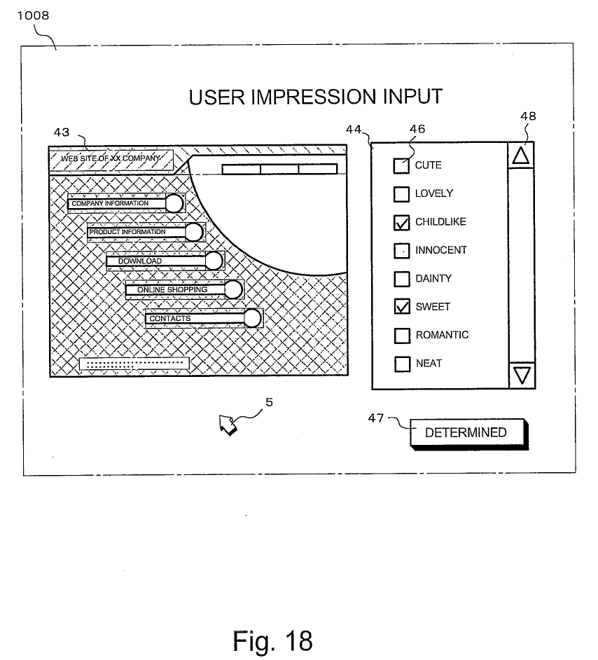

As shown in FIG. 18, the user impression input screen 1008 is divided into a region 43 for displaying the contents of the selected document data and a region 44 for displaying information representing an impression of the design in a list.

The control section 10 reads out the document data selected in step S30a from the design database kept in the storage section 12, and generates the image of the document data in the document data display region 43 and displays it. For example, if the document data of the web page is selected, the URL of the document data is read out from the database, and the document data is captured from the URL and displayed on the display as shown in FIG. 18.

The control section 10 further reads out information representing an impression of the design from the impression expression database kept in the storage section 12 and displays it on the impression expression display region 44. Information representing impressions included in the impression expression database is preferably selected and used as required according to an item of the document data from a group of abstract images or the like that abstractly represents plural adjective representing an impression of the design, color information including a color palette including sets of colors and an impression of the design.

In the exemplary embodiment, character information including a group of adjectives is read out from the impression expression database of FIG. 7 and displayed on the impression expression display region 44.

In step S30c, the user selects information appropriate for an impression the user had at first sight of the document displayed on the document data displaying region 43 by using the input section 14.

For example, as shown in FIG. 18, with the mouse pointer 5 displayed in the impression expression display region 44 in which adjectives are listed, the user moves the mouse pointer 5 to the check box 46 provided for the adjective that matches an impression the user got from the design and clicks the mouse on it by using the mouse to select the adjective. A check mark is displayed on the selected check box 46. By moving the mouse pointer 5 to the scroll button 48 and clicking the mouse, the user can change the display of the adjectives as required. When the adjectives have been selected, the user moves the mouse pointer 5 to the determined button 47 and clicks the mouse to save character information of the selected adjectives in the storage section 12. For example, character information such as “childlike”, “sweet” and “fresh” is selected and saved in the storage section 12.

A method for acquiring an impression of the user is not limited to this. That is to say, any method can be used as long as the method enables the user to easily input an impression of a design of the document data.

In step S30d, the user impression information is defined based on the information selected in step S30c. For deciding the user impression information, the impression evaluation database used in the desired impression decision process in step S10 is used.

The control section 10 reads information (adjective) selected in step S30c from the storage section 12 and references the impression evaluation database shown in FIG. 9 to extract impression information and a weighting factor for the impression information associated with the read out information (adjective).

For example, if the selected character information is “childlike”, in the example of the impression evaluation database of FIG. 9, “pretty” is extracted as impression information and 1.000 is extracted as a weighting factor for “pretty”. If “sweet” is selected, “romantic” is extracted as impression information and 1.000 is extracted as a weighting factor for “romantic”. If “fresh” is selected, “romantic” is extracted as impression information and 0.500 is extracted as a weighting factor for “romantic”.

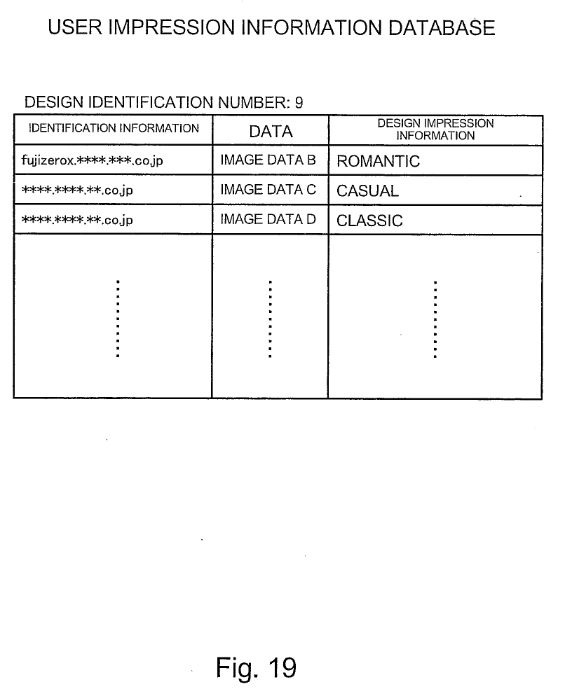

The control section 10 calculates the evaluation value that is a sum of weighting values for each of the selected items of impression information. Then, impression information whose evaluation value for each impression information is the biggest is set as a user impression information, and as shown in FIG. 19, a document and user impression information for each identification number of the design are associated with each other and saved in the storage section 12 as the user impression information database.

In the above example, the evaluation value for each impression information is 1.000 for “pretty” and 1.500 for “romantic”, respectively. Therefore, “romantic” whose evaluation value is the biggest is selected as user impression information.

It is assumed that the user impression information is defined based on the information selection only by one client, and it is also preferable to define the user impression information based on information acquired from plural persons by repeating the above steps. For example, if a web page introducing the company is created, plural visitors are allowed to select an adjective indicating an impression the visitor got from the design of an actual document, impression information is extracted, and a product value, which is a sum of weighting factors, is calculated for each of the extracted impression information. Further, the product values of the impression information for plural visitors are added to give an evaluation value for each item of impression information and the impression information with the biggest evaluation value is made the user impression information.

It is also preferable to define the user impression information in consideration of the change of the impression the visitor got from the design of the actual document as a client repeats the process within a time period.

A product value that is a sum of weighting factors is calculated for each item of the impression information for each item of impression information extracted each time a visitor performs the processing, the product value of the impression information is added for each item of impression information to be an evaluation value and make the impression information with the biggest evaluation value as the user impression information.

Although the evaluation value is assumed as a sum of weighting factors in the exemplary embodiment, the evaluation value is not limited to being acquired in such a manner. For example, the evaluation value may be calculated based on a weighting factor by a predetermined function such as making the product of the weighting factors for each item of impression information.

As the weighting factor associated with each item of information is set based on the level of importance of each item of information for each item of impression information in the exemplary embodiment, the user impression information clearly shows a tendency of the design of the actual document as in the above-mentioned desired impression decision process.

The processing of the user impression decision process is not limited to that described above. For example, if plural colors are used in the object of the design such as a presentation material, a web page, an appearance of a new material or a brand logo of a company, a group of color pallets that is a combination of colors or plural abstract images for giving different impressions to a person are registered as an impression expression database so that they are listed on the user impression input screen, and a client is permitted to make selection from the list, so that impression information associated with the selected color palette can be selected.

### <Modification>

In the above-mentioned exemplary embodiment, the processing is performed by using a weighting factor set based on the level of importance of each item of information for each item of impression information. In this modification, the processing is performed by setting a weighting factor so that each item of impression information will be evaluated evenly.

In step S30d, the user impression information indicating an impression the user got from the design of the actual document is defined based on the information selected in step S30c. Here, the processing is performed by using the impression evaluation database shown in FIG. 10.

The control section 10 reads out the information selected in step S30c from the storage section 12 and references the impression evaluation database shown in FIG. 10 to extract impression information and a weighting factor for the impression information associated with the read out information. The extracted impression information and weighting factor are saved in the storage section 12 in association with the identification number of the design.

For example, if the selected character information is “childlike”, in the example of the impression evaluation database of FIG. 10, “pretty” is extracted as impression information, and 0.286 is extracted as a weighting factor for “pretty”. If “sweet” is selected, “romantic” is extracted as impression information and 0.188 is extracted as a weighting factor for “romantic”. If “fresh” is selected, “romantic” is extracted as impression information and 0.063 is extracted as a weighting factor for the “romantic”.

The control section 10 calculates an evaluation value that is the sum of weighting factor for each item of the selected impression information. Then, the control section 10 sets impression information with the biggest value of evaluation values among respective items of impression information as the user impression information.

In the example above, the evaluation value for each item of impression information is 0.286 for “pretty” and 0.251 for “romantic”. Therefore, “pretty” with the biggest evaluation value is selected as the user impression information.

It is assumed that the user impression information is defined based on the information selection only by a client, but it is also possible to define the user impression information based on information acquired from plural persons by repeating the abovementioned steps. For example, if a web page for introducing the company is created, plural visitors are allowed to select adjectives indicating an impression that the visitor got from the design of the actual document and impression information is extracted, and a product value that is a sum of weighting factors is calculated for each item of extracted impression information. Further, the product values of the impression information for plural visitors are added to give evaluation value for each item of impression information and the impression information with the biggest evaluation value becomes the user impression information.

It is also preferable to define the user impression information in consideration of the change of the impression the visitor got from the design of the actual document as a client repeats the process within a time period. In such a case, a product value that is a sum of weighting factors is calculated for each item of impression information extracted each time the processing is performed, a product value of the impression information is added for each item of the impression information to give evaluation value and make the impression information with the biggest evaluation value the user impression information.

Although the evaluation value is assumed to be a sum of weighting factors in the modification, the evaluation value is not limited to be acquired in such a manner. For example, the evaluation value may be calculated based on a weighting factor by a predetermined function such as making the product of the weighting factors for each item of impression information.

As the weighting factor associated with each item of information is set so that impression information for each can be correctly evaluated, it is appropriate for the case where impressions to be subjected to the design creation are compared with each other or compared with the evaluation result of another impression.

Both of the impression information databases shown in FIG. 9 and FIG. 10 are stored in the stored part 12, and a user is permitted to select one of them as required, and this selected database is referenced as in the desired impression decision process. For example, in step S30d, it is preferable to select one of the impression information databases to reference when referencing, and perform the processing. That enables selection between extracting the user impression information clearly indicating a tendency of an impression the user got from the actual design, and extracting the user impression information so as to make a comparison with another impression information clear.

### 2-4. Impression Presentation/Correction Process

When the impression presentation/correction process button 26 is clicked in step S0, the processing proceeds to the impression presentation/correction process in step S40.

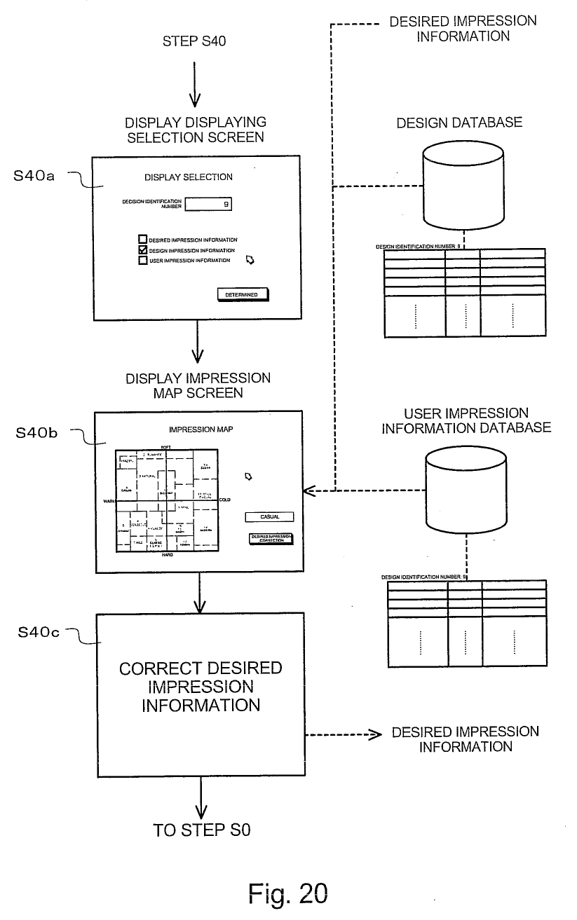

The impression presentation/correction process in step S40 is executed according to the flowchart shown in FIG. 20, and information on the design of the document is presented for the user based on the desired impression information database acquired in step S10, the design database acquired in step S20 and the user impression information acquired in step S30.

First in step S40a, the control section 10 causes the output section 16 to display a display selection screen 1010 and lets the operator select which item of information is to be displayed.

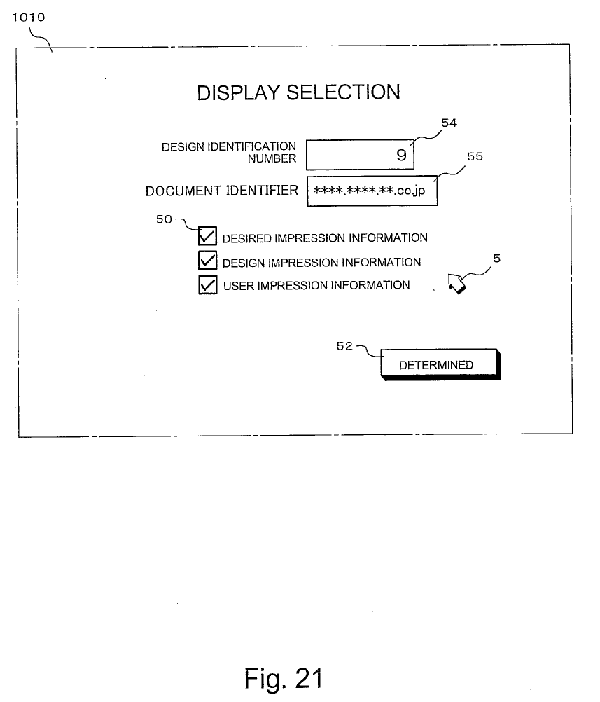

On the display selection screen 1010, as in FIG. 21, the identification number of the design to be displayed is input in the input box 54. The identifier indicating the document to be displayed (for example, URL) is input in the input box 55. Further, information to be displayed is selected from the user impression information, the design impression information and the user impression information, by selecting the check box 50 and clicking the determined button 52.

Next, the control section 10 receives the input of the information to be displayed, and displays at least one of the desired impression information, the design impression information and the user impression information on the impression map screen 1012 in step S40b.

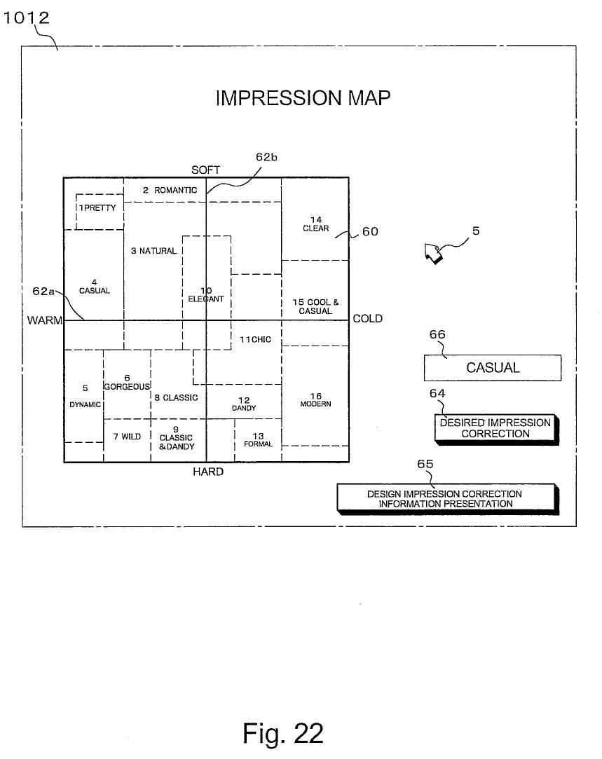

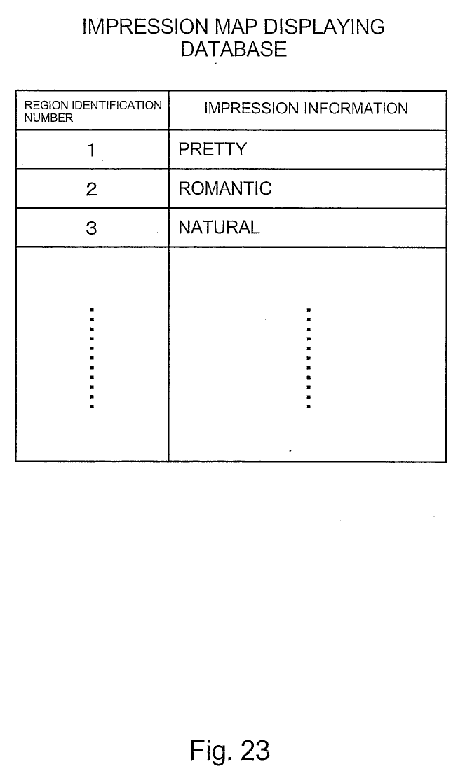

The impression map screen 1012 is divided into plural regions, each of which is added with a region identification number as shown in FIG. 22. On the other hand, the storage section 12 keeps items of information representing an impression for each region identification number in association with each other as an impression map displaying database as shown in FIG. 23.

Here, it is preferable to provide an axis on the impression map screen 1012, and the region identification numbers are allocated so that an impression changes in a predetermined tendency along the axis. For example, in the example of the impression map screen 1012 shown in FIG. 22, two orthogonal coordinates of an X coordinate indicating warmth of the design from “warm” to “cold” and a Y coordinate indicating hardness of the design from “soft” to “hard” are provided, and information representing impressions according to change in respective impressions is allocated. The method of allocating information to the impression map screen 1012 is not limited to that described above, and setting of the coordinates can be changed according to the kind of objective design.

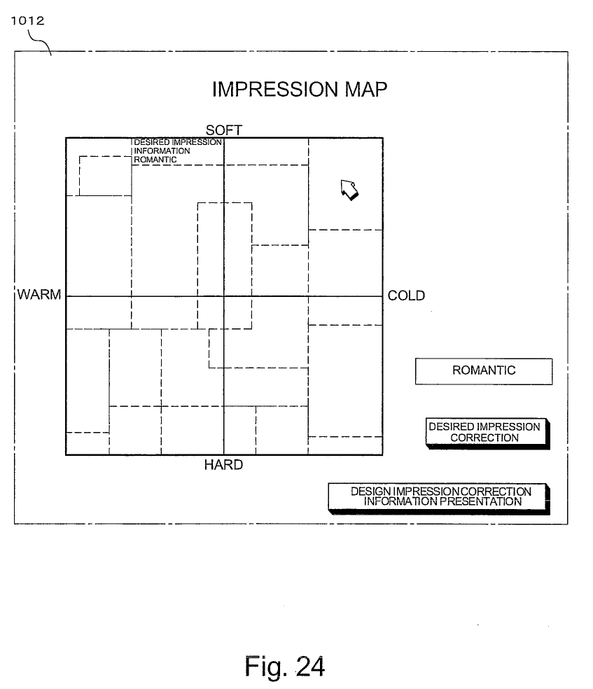

If the desired impression information is selected in step S40a, the control section 10 references the desired impression information database and extracts impression information kept in association with the biggest value as the desired impression information. Then, as shown in FIG. 24, the desired impression information associated with the design identification number is superimposed on the impression map screen 1012.

Here, the control section 10 extracts the region identification number associated with the desired impression information by referencing the impression map displaying database. Then, the desired impression information added with the extracted region identification number is displayed corresponding to a region on the impression map screen 1012.

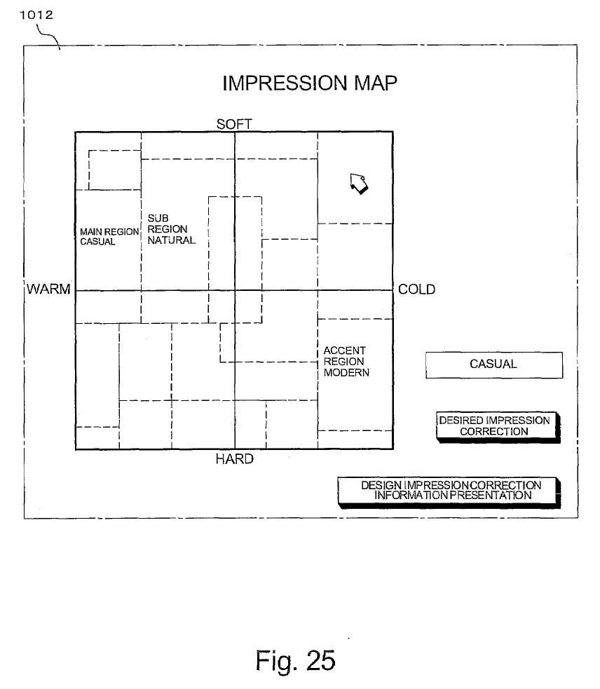

It is preferable to reference the desired impression information database and extract the impression information associated with the biggest value, the impression information associated with the second biggest value and the impression information associated with the third biggest value as impressions that are objects of the designs of the main region, the sub region and the accent region of the document. In such a case, as shown in FIG. 25, it is preferable to display the respective desired impression information superimposed on the impression map screen 1012 as shown in FIG. 25.

If the desired impression information is set by using the impression evaluation database of FIG. 9, the desired impression information displayed on the impression map screen 1012 clearly shows a tendency of the impression that is an object of the design creation. If the desired impression information is set by using the impression evaluation database of FIG. 10, the desired impression information displayed on the impression map screen 1012 can be objectively and correctly compared with the design impression information and the user impression information displayed on the impression map screen 1012.

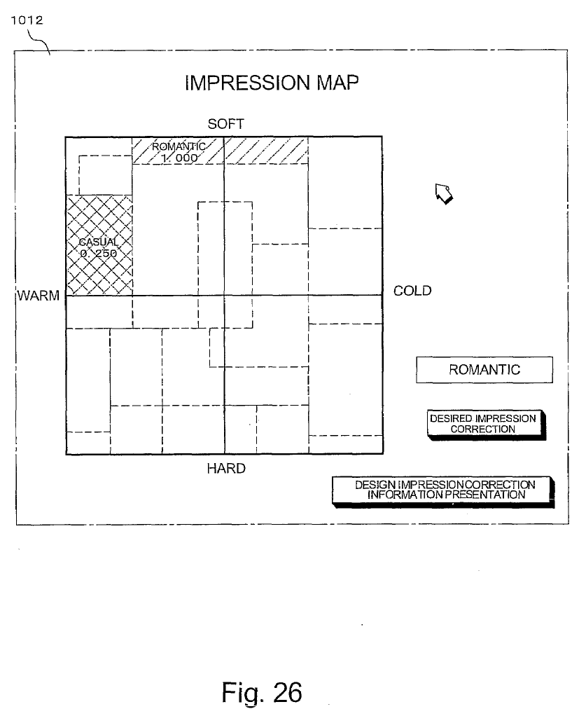

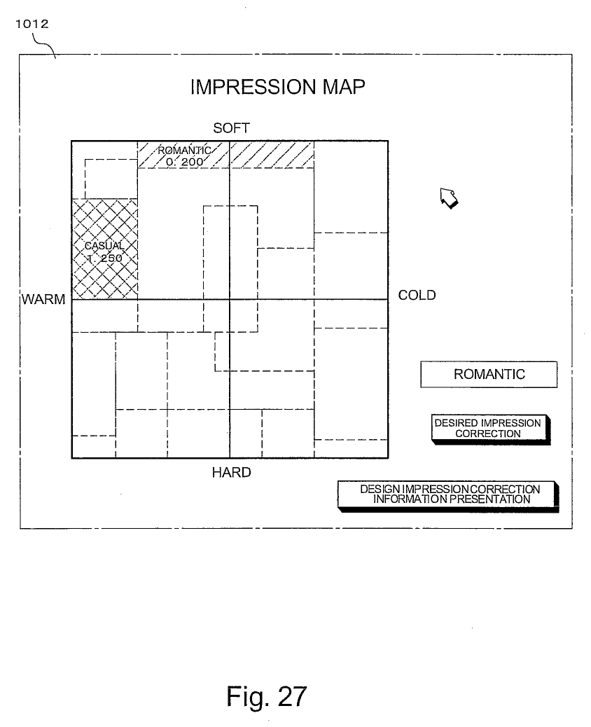

When the design impression information is selected in step S40a, the design database is referenced and impression information and the evaluation value associated with the design identification number are superimposed on the impression map screen 1012 as in FIG. 26 and FIG. 27.

The control section 10 reads out impression information and an evaluation value associated with the document specified to be output from the design database. Here, a set of impression information and an evaluation value acquired based on the first design evaluation database is read out. Then, by referencing the impression map displaying database, and the impression information and the evaluation value corresponding to a region associated with the region identification number extracted on the impression map screen 1012 added with the extracted region identification number is displayed.

For example, in the example of the design database of FIG. 13, if the document at the highest stage (image data A) is to be output, a set of the impression information “romantic” and the evaluation value 1.000 and a set of the impression information “casual” and the evaluation value 0.250 . . . are read out and superimposed on the impression map screen 1012 as shown in FIG. 26. Here, for the impression information whose evaluation value is 0, nothing needs to be displayed in the corresponding screen region.

Next, after a predetermined time period has passed, a set of the impression information and the evaluation value is read out based on the second design evaluation database. Then, by referencing the impression map displaying database, the region identification number associated with each item of the read out impression information is extracted and the impression information and the evaluation value corresponding to a region on the impression map screen 1012 added with the extracted region identification number is displayed.

For example, in the example of the database of FIG. 13, a set of the impression information “romantic” and the evaluation value 0.200 and a set of the impression information “casual” and the evaluation value 1.250 . . . are read out for the image data A at the highest stage and superimposed on the impression map screen 1012 as shown in FIG. 27.

Here, it is preferable to fill a predetermined color in the screen region that displays the impression information and the evaluation value and the impression information and the evaluation value are superimposed on that. For example, it is preferable to display each screen region with a color that is associated with each item of impression information.

It is also preferable to adjust the color strength of the corresponding screen region according to the magnitude of the absolute value associated with each item of impression information. For example, a visual effect can be easily obtained by displaying the color of the screen region associated with the corresponding impression information as the absolute value of the evaluation value increases. Here, it is also preferable to gradually change, over time, from a color strength representing the impression information and the evaluation value based on the first design evaluation database to a color strength representing the impression information and the evaluation value based on the second design evaluation database. With such output processing, a transition from the intuitive impression to the rational impression in time can be presented.

It is preferable to display a switching button and the like for switching display between the impression information and the evaluation value by the first design evaluation database and the impression information and the evaluation value by the second design evaluation database on the impression map screen 1012 so that the display of the impression information and the evaluation value switches each time it is clicked by the mouse.

It is also preferable to display information representing a difference between the evaluation value acquired from the first design evaluation database and the evaluation value acquired from the second design evaluation database is displayed on the impression map screen 1012 for each item of impression information.

The control section 10 obtains the difference value between the evaluation value acquired from the first design evaluation database and the evaluation value acquired from the second design evaluation database and displays the difference value in the screen region association with the impression information.

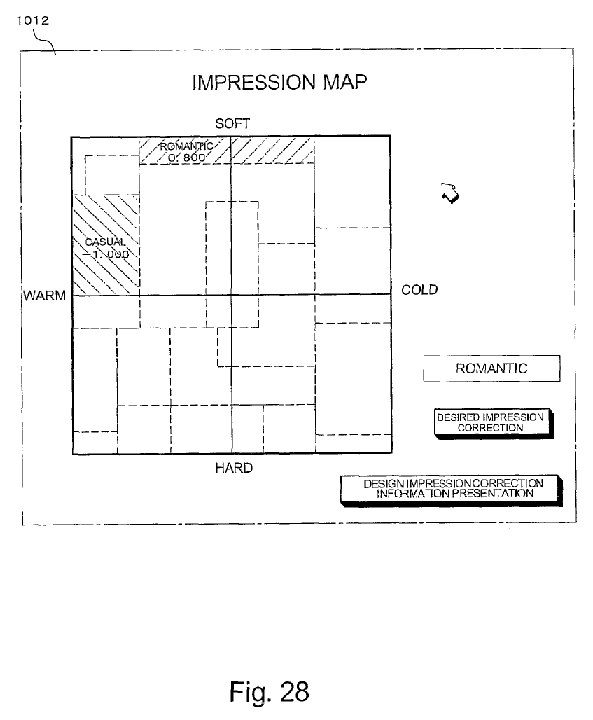

For example, as the evaluation value 1.000 and the evaluation value 0.200 are registered for the impression information “romantic” for the screen data A at the highest stage in the example of the design database of FIG. 13, the difference value becomes 0.800. Similarly, as the evaluation value 0.250 and the evaluation value 1.250 are registered for the impression information “casual”, the difference value becomes −1.000. Similarly, the difference value of the evaluation values is calculated for other impression information. The control section 10 superimposes the difference value calculated in this manner on the impression map screen 1012, as shown in FIG. 28.

Here, it is preferable to facilitate the identification of the displayed difference value by changing the display colors of the information according whether the difference value is positive or negative, and the magnitude of the absolute value of the difference value. For example, if the difference value is positive, i.e., the rational impression is weaker than the intuitive impression, a reddish color is filled in the region allocated by the impression information on the impression map screen 1012 with the difference value displayed on it. If the difference value is negative, i.e., the rational impression is stronger than the intuitive impression, a bluish color is filled in the region allocated by the impression information on the impression map screen 1012 with the difference value displayed on it. It is also preferable to use a warm color for the case where an intuitive impression is strong, and to use a cold color for the case where a rational impression is strong. Further, a reddish color or a bluish color can be strengthened or weakened according to the absolute value of the difference value.

As such, by representing a difference in time of an impression of the design acquired based on the physical features of the design as numerals and using visual representation, the user is able to correctly recognize the change of an impression in time acquired from the design.

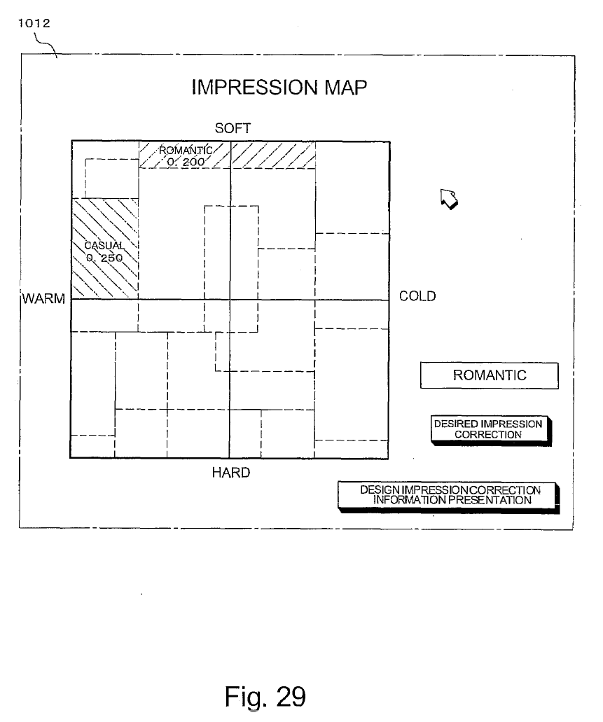

The control section 10 may display the lower of the evaluation value acquired from the first design evaluation database and the evaluation value acquired from the second design evaluation database on the impression map screen 1012. For example, in the example of the design database of FIG. 13, as the evaluation value 1.000 and the evaluation value 0.200 are registered for the impression information “romantic” for the image data A at the highest stage, the lower value 0.200 is extracted. Similarly, the evaluation value 0.250 and the evaluation value 1.250 are registered for the impression information “casual”, the lower value 0.250 is extracted. The control section 10 superimposes the difference value calculated in this manner on the impression map screen 1012 as shown in FIG. 29.

Here, it is preferable to change a display color and the like of the information according to which of the evaluation value acquired from the first design evaluation database and the evaluation value acquired from the second design evaluation database is lower. For example, if the rational impression is weaker than the intuitive impression, a reddish color is filled in the region allocated by the impression information on the impression map screen 1012 with the extracted color being displayed on it. If the rational impression is stronger than the intuitive impression, a bluish color is filled in the region allocated by the impression information on the impression map screen 1012 with the extracted color being displayed on it. In that case, it is also preferable to use a warm color for the case where the intuitive impression is stronger, and a cold color is used for the case where a rational impression is stronger.

As such, by representing the difference in time of the impression of the design acquired based on the physical feature of the design as numerals and visual representation, the user is able to correctly recognize the change of an impression in time acquired from the design.

It is also possible to extract the impression information associated with the biggest value among the impression information and the evaluation values registered in the design database in association with each document as the design impression information and display the impression information in the associated screen region on the impression map screen 1012. It is also preferable to display the document data corresponding to each item of design impression information instead of or in addition to each item of design impression information.

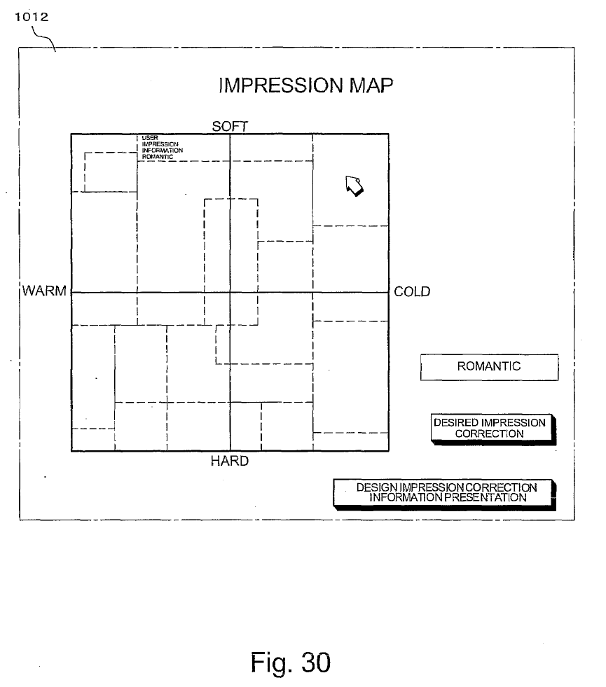

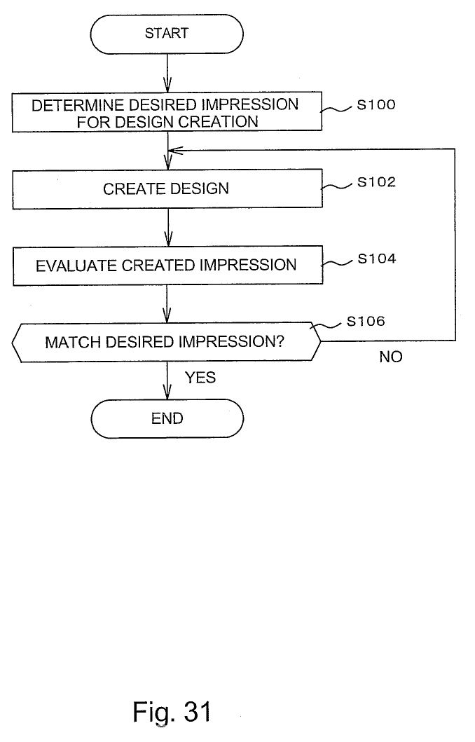

If the user impression information is selected in step S40a, the control section 10 references the user impression information database and extracts the impression information kept in association with the highest value as the user impression information. Then, as shown in FIG. 30, the user impression information included in the user impression information database associate with the design identification number is superimposed on the impression map screen 1012. Here, it is preferable to facilitate identification of the displayed information by changing the displayed color of the information for each document data included in the user impression information database.

If the user impression information is set by using the impression evaluation database of FIG. 9, the user impression information displayed on the impression map screen 1012 correctly shows a tendency of the impression that is to be subjected to the design creation. If the user impression information is set by using the impression evaluation database of FIG. 10, the user impression information displayed on the impression map screen 1012 can be objectively and correctly compared with the desired impression information or the design impression information.

Further, if both of the desired impression information and the design impression information are selected in step S40a, both of the desired impression information and the design impression information associated with the design identification number are superimposed on the image map screen 1012. Similarly, if both of the desired impression information and the user impression information are selected, if both of the design impression information and the user impression information are selected, or if all of the desired impression information, the design impression information and the user impression information are selected, each item of information is superimposed on the impression map screen 1012.

As such, by superimposing the desired impression information, the design impression information and the user impression information are superimposed on one impression map screen 1012, the design creator, the client and the user can visually compare and recognize the impression to be subjected to the design creation, an impression included in the actual design and an impression the user got from the actual design. Here, as each of the items of information is displayed along the coordinate indicating the impression tendency on the impression map screen 1012, how much the objective impression is, the fact that the impression of the actual design and the impression the user got differ, what kind of tendency the difference has, and the like can be clearly recognized.

Further, by obtaining the design impression information for the other company's web page or the design of the product in step S20, those items of information and the desired impression information can be compared and recognized. That facilitates recognition of whether the impression of another company's web page or the impression of other product matches with the desired impression of the design or not.

Further, by acquiring the user impression information from plural users for the same design in step S30, the distribution tendency of the user impression information can be easily recognized on the impression map screen 1012. Whether the desired impression information or the design impression information matches with the distribution tendency of the user impression information can be recognized at a glance.

An abstract image may be associated with each region on the impression map screen 1012 and displayed instead of or in addition to an adjective in a region corresponding to the desired impression information, the design impression information and the user impression information as the desired impression information, the design impression information and the user impression information. This is the same in the case where the color palette is used.

Further, in the exemplary embodiment, correction of the desired impression information or presentation of the information that helps the correction of the design impression can be performed. By moving the mouse pointer 5 onto the desired impression correction button 64 or the design impression correction information presentation button 65 on the impression map screen 1012 and clicking the mouse, the processing proceeds to step S40c.

As the correction of the desired impression information is instructed, the control section 10 starts setting processing of the desired impression information.

The operator moves the mouse pointer 5 in the region of the impression map screen 1012 and clicks the mouse by referencing the design impression information or the user impression information displayed on the impression map screen 1012. The control section 10 acquires the position of the mouse pointer 5 and references the impression expression database to set information representing the impression allocated with the region as new desired impression information. Here, it is also preferable to provide a region 66 for displaying the desired impression information and display the desired impression information to facilitate checking of the newly set desired impression information.

With the above-mentioned desired impression information setting method, it is possible to superimpose the web design of the competing company on the impression map screen 1012 as the design impression information, and when the desired impression of the web design of a person's own company is desired to be different from the web design of the competing company, an appropriate desired impression information can be easily set by specifying a region that does not overlap with the region in which the design impression information of the web design of the competing company is displayed. In contrast, if it is desired to be a web design with a similar impression as that of the competing company, an appropriate desired impression information can be set by specifying the region in which the design impression information of the web design of the competing company can be set. Similarly, by superimposing the user impression information on the impression map screen 1012, new desired impression information can be set with reference to the impression received by the user.

By moving the mouse pointer 5 to the design impression correction information presenting button 65 provided on the impression map screen 1012 and clicking the mouse, an operator can present information required for correction of the design impression information. For example, it is preferable to make a color combination of the background region, the main region, and the accent region of the design appropriate for the impression allocated to each region of the impression map screen 1012 into a database in advance and superimpose the set of colors corresponding to the region in which the desired impression information is displayed. By changing the design into the displayed set of colors, it can be closer to the desired impression.

In this manner, by performing presentation of the supporting information of the correction of the desired impression information or the correction of the design on the same impression map screen 1012, a task can be performed by visually recognizing the desired impression, an impression included in the actual design, and an impression the user, on the same impression map screen 1012.

That is to say, according to the exemplary embodiment, whether or not an impression to be subjected to the design creation matches with the impression included in the actual design and the impression the user got from the actual design can be recognized on the same impression map screen.

That enables the client or the design creator to visually recognize whether the desired impression setting of the design creation is appropriate or not and easily correct the desired impression or the design impression. In the task of design creation, the client and the design creator easily negotiate information so that they can smoothly perform the tasks.

Further, based on the impression desired by the client or the impression the user got from the design, the orientation of the design correction can be easily found.

Although a visual design such as a web page, a presentation material, a product design and the like are mentioned in the above-mentioned exemplary embodiment, the same effect can be obtained by acquiring the desired impression information, the design impression information and the user impression information also for audio data such as commercial audio and the like, and displaying them on the same impression map screen.

What is claimed is:

1. A computer readable recording medium storing a design creation supporting program causing a computer having a memory that stores a plurality of design evaluation databases in which an amount of physical features in a design of a document, impression information representing an impression sensed by a human viewing the document, and a weighting factor of the impression information are associated with one other, to execute a process for supporting design creation, the process comprising:
extracting the amount of feature from the design of the actual document;
extracting impression information and its weighting factor that are associated with the amount of feature extracted in the process for extracting the amount of feature from the design of the actual document by referencing the plurality of design evaluation databases; and
presenting information representing an evaluation value calculated based on image information extracted from the plurality of design evaluation databases in the process for extracting the impression information and its weighting factor and the weighting factor for each of the items of image information extracted for the plurality of design evaluation databases.

2. The recording medium according to claim 1,
wherein the plurality of design evaluation databases comprises:
a first design evaluation database generated based on an impression a group of examinees got immediately after viewing a plurality of documents with different amounts of physical features;
a second design evaluation database generated based on an impression a group of examinees got after viewing a plurality of documents with different amounts of physical features for a predetermined period of time.

3. The recording medium according to claim 1,
wherein information representing an evaluation value of the impression information is a difference value of evaluation values for the respective items of impression information between the plurality of design evaluation databases.

4. The recording medium according to claim 2,
wherein information representing an evaluation value of the impression information is a difference value of evaluation values for the respective items of impression information between the plurality of design evaluation databases.

5. The recording medium according to claim 1,
wherein information representing an evaluation value of the impression information is the least among the evaluation values for the respective items of impression information for the plurality of design evaluation databases.

6. The recording medium according to claim 2,
wherein information representing an evaluation value of the impression information is the least among the evaluation values for the respective items of impression information for the plurality of design evaluation databases.

7. The recording medium according to claim 1,
wherein the process for presenting divides a region of an output screen into a plurality of divided screen regions, allocates impression information for each of the divided screen regions, and displays information representing an evaluation value of the impression information in the divided screen region.

8. The recording medium according to claim 1,
wherein the process for presenting displays information representing the evaluation value of the impression information by temporally changing it.

9. The recording medium according to claim 8,
wherein the process for presenting represents the evaluation value of the impression information by strength of color and displays a difference of evaluation values for the respective impression information by temporally changing the strength of color.

10. A design creation supporting apparatus, comprising
a memory for storing a plurality of design evaluation databases in which an amount of physical features in a design of a document, impression information representing an impression sensed by a human viewing the document, and a weighting factor of the impression information are associated with one other; and
a controller for:
extracting the amount of feature from the design of the actual document;
extracting impression information and its weighting factor that are associated with the amount of feature extracted at the amount of feature extracting process by referencing the plurality of design evaluation databases; and
presenting information representing an evaluation value calculated based on image information extracted from the plurality of design evaluation databases in the process for extracting the impression information and its weighting factor and the weighting factor for each of the items of image information extracted for the plurality of design evaluation databases.

11. A computer data signal embodied in a carrier wave for enabling a computer having a memory that stores a plurality of design evaluation databases in which an amount of physical features in a design of a document, impression information representing an impression sensed by a human viewing the document, and a weighting factor of the impression information are associated with one other, to execute a process for supporting design creation, the process comprising:
extracting the amount of feature from the design of the actual document;
extracting process for extracting impression information and its weighting factor that are associated with the amount of feature extracted at the amount of feature extracting process by referencing the plurality of design evaluation databases; and
an outputting process for presenting information representing an evaluation value calculated based on image information extracted from the plurality of design evaluation databases in the process for extracting the impression information and its weighting factor and the weighting factor for each of the items of image information extracted for the plurality of design evaluation databases.
